(19) United States
(12) Patent Application Publication
(10) Pub. No.: US 2026/0084474 A1
(43) Pub. Date: Mar. 26, 2026

(54) ROBOT MONITORING METHOD AND ROBOT SYSTEM

(71) Applicant: KAWASAKI JUKOGYO KABUSHIKI KAISHA, Kobe-shi (JP)

(72) Inventors: Yoshitaka MURAMATSU, Kobe-shi (JP); Koki TAMURA, Kobe-shi (JP)

(73) Assignee: KAWASAKI JUKOGYO KABUSHIKI KAISHA, Kobe-shi (JP)

(21) Appl. No.: 19/329,131

(22) Filed: Sep. 15, 2025

(30) Foreign Application Priority Data
Sep. 24, 2024 (JP) 2024-164995

(51) Int. Cl. B60C 23/06; B25J 9/16; B25J 19/00; B25J 19/06

(52) U.S. Cl. CPC B60C 23/06; B25J 9/1664; B25J 9/1674; B25J 19/0066; B25J 19/061

(57) ABSTRACT

A robot monitoring method includes: acquiring information related to rotation of wheels of a robot while the robot is traveling along a route in a specific area; calculating, by a calculation circuit, a travel distance of the robot along the route based on the acquired information; calculating, by the calculation circuit, an actual distance corresponding to the route traveled by the robot; and in a case where a difference between the calculated travel distance and the actual distance is greater than a predetermined threshold, generating, by an alert generator, an alert regarding wear of the wheels of the robot.

### CROSS-REFERENCE TO RELATED APPLICATION

This application claims priority to Japanese Patent Application No. 2024-164995 filed on September 24, 2024, the entire disclosure of which is incorporated herein by reference.

### BACKGROUND

In conventional management methods for moving objects, an automatic guided vehicle (AGV) as a moving object is managed. The AGV is equipped with an external sensor, and generates first position information based on the surrounding environment scanned by the external sensor together with an environmental map. The AGV also generates second position information from measured values of the rotational speed of its drive wheels. In the conventional management method, whether the drive wheels are slipping is determined based on the difference between the first position information and the second position information. When the drive wheels are slipping, the rotational speed of the electric motor is reduced. The conventional method thus allows the AGV to travel while reducing slipping of the drive wheels.

### SUMMARY

In a system including a robot that travels within a specific area using wheels, the travel distance of the robot based on the number of wheel rotations initially corresponds to the map distance calculated from a map of the specific area. However, when the system is operated over a long period of time, the deviation between the travel distance and the map distance may increase due to temporal changes in the system as a whole, including the robot.

The technology disclosed herein relates to a robot monitoring method. The robot monitoring method includes: acquiring information related to rotation of a wheel of a robot while the robot is traveling along a route in a specific area; calculating, by a calculation circuit, a travel distance of the robot along the route based on the acquired information; calculating, by the calculation circuit, a map distance corresponding to the route traveled by the robot, based on a map of the specific area; and in a case where the difference between the calculated travel distance and the map distance is greater than a predetermined threshold, generating, by an alert generator, an alert related to wear of the wheel of the robot.

### BRIEF DESCRIPTION OF THE DRAWINGS

FIG. 1 shows part of an automobile manufacturing factory in which a robot system is installed.

FIG. 2 is a rear view of a work area.

FIG. 3 is a block diagram of the robot system.

FIG. 4 is a block diagram of a transport robot.

FIG. 5 shows a wheel of the transport robot.

FIG. 6 is a functional block diagram of a controller of the transport robot.

FIG. 7 is a flowchart of control of the transport robot.

### DETAILED DESCRIPTION OF THE DRAWINGS

Hereinafter, an embodiment of a robot management method and a robot system will be described with reference to the drawings. The robot management method and robot system described herein are merely by way of example.

### Overall Structure of Robot System

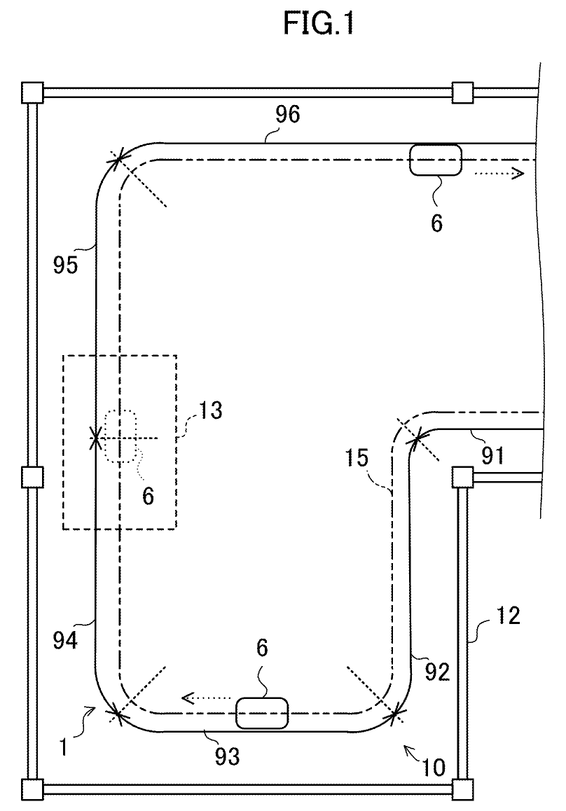

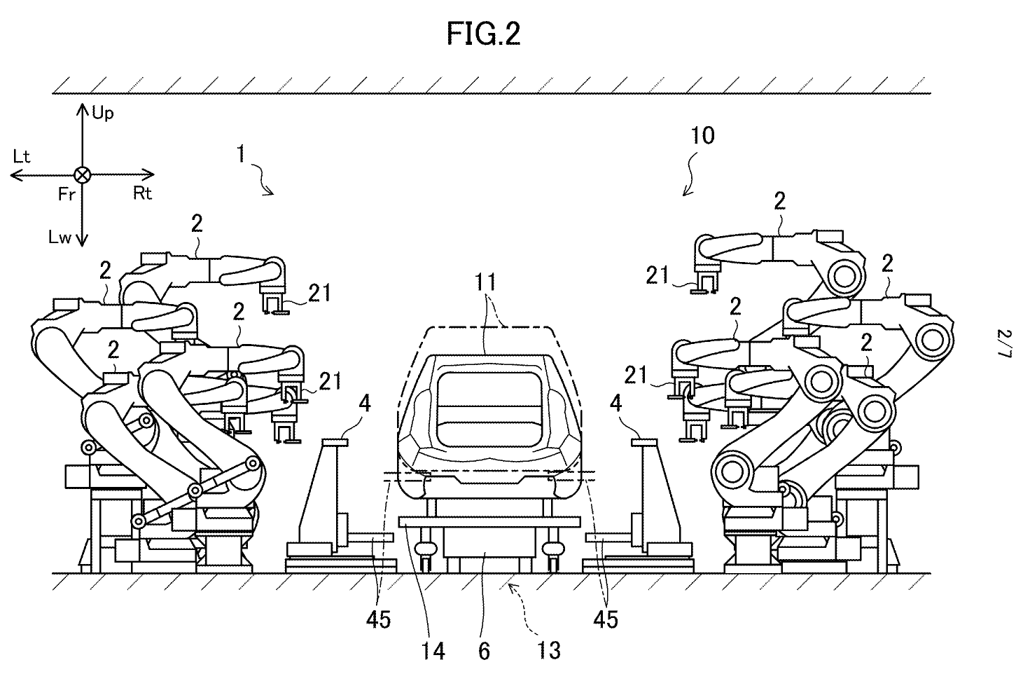

FIG. 1 shows part of an automobile manufacturing factory to which a robot system 1 is applied. FIG. 2 illustrates a work area 13 in the manufacturing factory where operations are performed on a workpiece.

A building 12 of the manufacturing factory is equipped with a production line 10. The inside of the building 21 is an example of a specific area. In the illustrated example, the production line 10 is a line where welding, more specifically, spot welding, is performed on a body 11 of an automobile. The workpiece is the body 11.

The robot system 1 is installed on the production line 10. The robot system 1 includes an autonomous transport robot 6 described later. On the production line 10, the body 11 is transported by the transport robot 6. The work area 13 refers to the area where the workpiece transported by the transport robot 6 remains to undergo an operation. The work area 13 is part of the production line 10. In the illustrated example, the production line 10 includes a single work area 13. However, the number of work areas 13 in the production line 10 is not limited to any particular number.

The front, rear, right, left, top, and bottom of the robot system 1 are defined as follows with respect to the body 11 that is to undergo operations in the work area 13. The longitudinal direction of the robot system 1 is the direction perpendicular to the plane of FIG. 2. The front of the robot system 1 corresponds to the front of the body 11, and the rear of the robot system 1 corresponds to the rear of the body 11. As will be described later, the longitudinal direction corresponds to the direction in which the body 11 is transported. The right side of the robot system 1 is the right side of FIG. 2. The right side of the robot system 1 corresponds to the right side of the body 11. The left side of the robot system 1 corresponds to the left side of the body 11. The lateral direction is the horizontal direction perpendicular to the longitudinal direction. The top of the robot system 1 is the upper side of FIG. 2, and the bottom of the robot system 1 is the lower side of FIG. 2. The top and bottom of the robot system 1 correspond to the top and bottom of the body 11. The vertical direction is the vertical direction perpendicular to the longitudinal direction. These definitions are used for the description of the robot system 1, and are not intended to limit the structure or configuration of the robot system 1 and the components of the robot system 1 disclosed herein.

As shown in FIG. 2, industrial robots 2, 4 are installed in the work area 13. The industrial robots 2, 4 perform spot welding on the body 11 in the work area 13. The robot system 1 may not include the industrial robots 2, 4.

Multiple industrial robots 2 are installed in the work area 13. The industrial robots 2 are positioned on both sides of the body 11. Specifically, multiple industrial robots 2 are arranged along the longitudinal direction of the body 11 on the right side of the body 11, and multiple industrial robots 2 are also arranged along the longitudinal direction of the body 11 on the left side of the body 11. The industrial robots 2 perform an operation on the body 11 transported into the work area 13 as a workpiece. The operation performed by the industrial robots 2 on the body 11 is welding. The industrial robots 2 perform welding at respective positions on the body 11. The industrial robots 2 are vertical articulated robots with five to seven axes. As shown in FIG. 2, each industrial robot 2 includes a welding gun 21 as an end effector. However, the industrial robots 2 are not limited to vertical articulated robots. The number of industrial robots 2 is not limited to any particular number, and the arrangement of the industrial robots 2 is not limited to any specific arrangement.

The industrial robot 4 is a locator 4 that lifts and supports the body 11 during the operation of the industrial robots 2. Multiple locators 4 are installed in the work area 13. The locators 4 are positioned on both sides of the body 11. Each locator 4 is located between the industrial robots 2 and the transport robot 6. The relative arrangement of the industrial robots 2, locators 4, and transport robot 6 in the work area 13 is not limited to the example shown in FIG. 2. In the illustrated example, the locators 4 are three-axis Cartesian robots. Each locator 4 includes a rod 45 that engages with the body 11. The rod 45 extends horizontally, and the distal end of the rod 45 engages with the body 11. Each locator 4 changes the position of the distal end of its rod 45 in the longitudinal, lateral, and vertical directions.

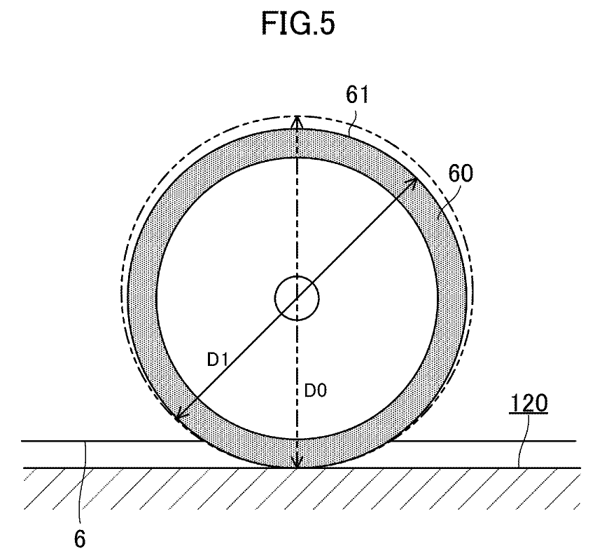

The robot system 1 includes one or more transport robots 6. The transport robot 6 transports a workpiece into the work area 13. The transport robot 6 travels on a flat floor surface 120 of the factory (see FIG. 5). As shown in FIG. 2, the body 11 is placed on a transport platform 14. The transport robot 6 is positioned under the transport platform 14 and engages with the transport platform 14. The transport robot 6 transports the body 11 via the transport platform 14. Alternatively, the transport robot 6 may directly support the body 11 without using the transport platform 14. The external appearance of the transport robot 6 shown in FIG. 2 is merely illustrative. The structure of the transport robot 6 will be described later.

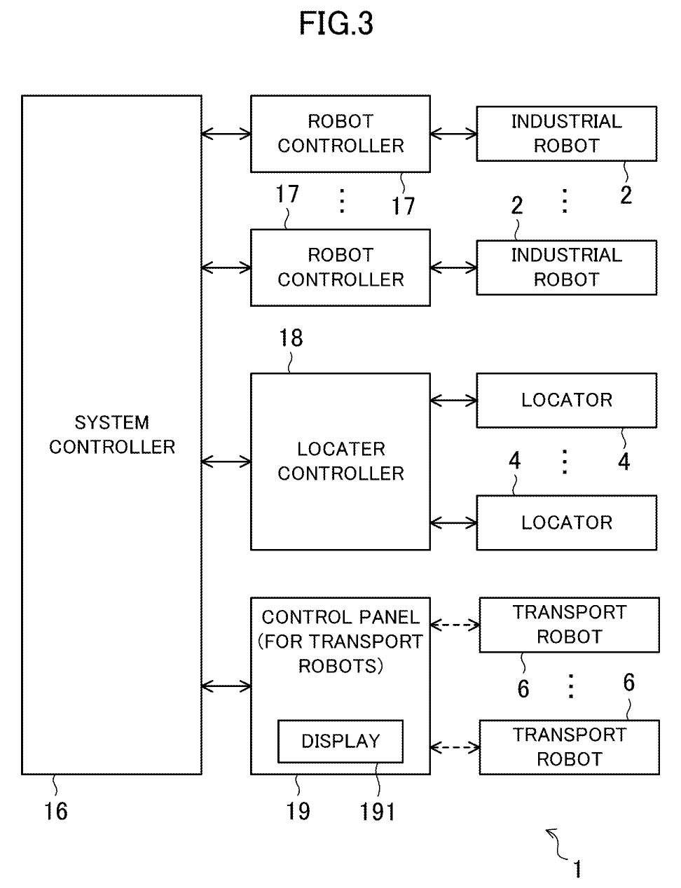

FIG. 3 is a block diagram of the robot system 1. The robot system 1 includes a system controller 16. The system controller 16 controls the entire robot system 1. The robot system 1 may not include the system controller 16.

The robot system 1 includes a robot controller 17. The robot controller 17 is electrically connected to the system controller 16. This electrical connection includes wired or wireless connection. The robot controller 17 is also electrically connected to an industrial robot 2. Robot controllers 17 are connected in a one-to-one manner to the industrial robots 2. Accordingly, the robot system 1 includes as many robot controllers 17 as industrial robots 2. Each robot controller 17 controls the corresponding industrial robot 2. More specifically, each robot controller 17 receives control signals from the system controller 16 and outputs control signals to the corresponding industrial robot 2. In this example, the industrial robot 2 performs welding on the body 11 in response to the control signals from the robot controller 17. The robot system 1 may not include the robot controllers 17.

The robot system 1 includes a locator controller 18. The locator controller 18 is electrically connected to the system controller 16. This electrical connection includes wired or wireless connection. The locator controller 18 is also electrically connected to the locators 4. The locator controller 18 controls the locators 4. More specifically, the locator controller 18 receives control signals from the system controller 16 and outputs control signals to the locators 4. In response to the control signals from the locator controller 18, the locators 4 position and support the body 11 delivered from the transport robot 6 at a predetermined position. The robot system 1 may not include the locator controller 18.

The robot system 1 includes a control panel 19. The control panel 19 is electrically connected to the system controller 16. This electrical connection includes wired or wireless connection. The control panel 19 is also electrically connected to the one or more transport robots 6.

The control panel 19 controls the transport robots 6. More specifically, the control panel 19 receives control signals from the system controller 16 and outputs control signals to the transport robots 6. The robot system 1 may not include the control panel 19.

### Structure of Transport Robot

The transport robot 6 autonomously travels to transport a workpiece (the body 11 in the illustrated example) to the work area 13. The transport robot 6 may be, for example, an AGV. As shown by the two-dot chain line in FIG. 1, the AGV autonomously travels along a predetermined route 15 to carry the body 11 into the work area 13. The route 15 may be set by, for example, magnetic tape placed on the floor surface 120. The transport robots 6 travel along substantially the same route 15. Each transport robot 6 has a simultaneous localization and mapping (SLAM) function. With this SLAM function, each transport robot 6 can autonomously travel using a map 661 and a scanner 65 described later.

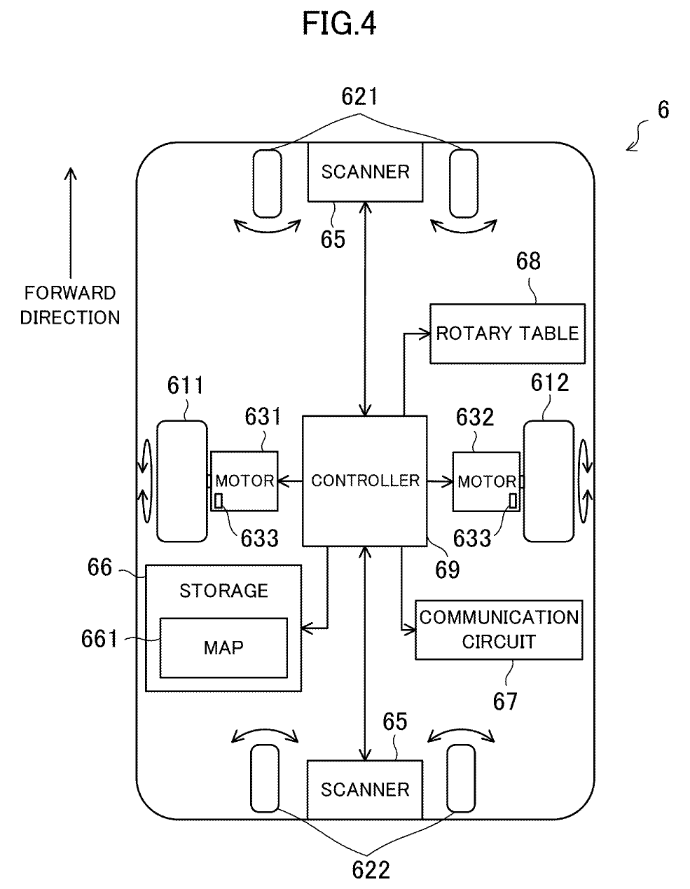

FIG. 4 shows the structure of the transport robot 6. The structure of the transport robot 6 in FIG. 4 is an example of the transport robot 6.

The transport robot 6 includes wheels that roll on the floor surface 120. The wheels include drive wheels 611, 612 and caster wheels 621, 622. The drive wheels 611, 612 are independent. The transport robot 6 is an independently driven transport vehicle. The drive wheel 611 is located on the left side of an intermediate portion in the longitudinal direction of the transport robot 6. The drive wheel 612 is located on the right side of the intermediate portion of the transport robot 6. The rotational axes of the drive wheels 611, 612 extend in the lateral direction and are coaxial. The drive wheel 611 is mechanically connected to a motor 631, and the drive wheel 612 is mechanically connected to a motor 632. The drive wheels 611, 612 can rotate independently of each other.

The motors 631, 632 are driven with electric power supplied from a battery. The battery is mounted on the transport robot 6. The motors 631, 632 are the traction drive source of the transport robot 6. The driving forces of the motors 631, 632 are transmitted to the drive wheels 611, 612 to rotate the drive wheels 611, 612, respectively.

Each of the motors 631, 632 includes an encoder 633. Each encoder 633 outputs to a controller 69, described later, information relating to the rotation of a corresponding one of the drive wheels 611, 612, specifically, signals related to the rotational direction and rotational speed of the corresponding one of the drive wheels 611, 612.

When the drive wheels 611, 612 rotate in the same direction at the same rotational speed, the transport robot 6 travels straight ahead. When the drive wheels 611, 612 rotate in the same direction at different rotational speeds, the transport robot 6 changes its direction of travel. When the drive wheels 611, 612 rotate in opposite directions, the transport robot 6 pivots in place, that is, rotates about a vertical axis. In the following description, the drive wheels 611, 612 may be collectively referred to as the drive wheel(s) 61.

FIG. 5 shows the drive wheel 61. The drive wheel 61 includes a tire 60. The tire 60 is in contact with the floor surface 120 and rolls on the floor surface 120. The tire 60 is formed of, for example, rubber so as to increase frictional resistance with the floor surface 120. As the travel distance of the transport robot 6 increases, the tire 60 wears. When the tire 60 wears, the diameter of the drive wheel 61 decreases from an initial diameter D0, shown by the two-dot chain line in FIG. 5, to D1.

The caster wheel 621 is located at the lateral center of the front end of the transport robot 6. The caster wheel 622 is located at the lateral center of the rear end of the transport robot 6. Each of the caster wheels 621, 622 can change its orientation. The transport robot 6 may include one caster wheel.

The transport robot 6 includes a scanner 65. The scanner 65 acquires information on the surroundings of the transport robot 6. The scanner 65 may include, for example, a Light Detection and Ranging (LiDAR). The scanner 65 is not limited to a LiDAR. The scanner 65 is located at both the front end and the rear end of the transport robot 6.

The transport robot 6 includes a storage 66. The storage 66 stores various types of data. The data stored in the storage 66 include a map 661. Examples of the storage 66 include magnetic recording media such as a hard disk drive (HDD), optical recording media such as a Blu-ray disc and a digital versatile disc (DVD), and semiconductor recording media such as a solid state drive (SSD) and a memory card. The map 661 is a map of the inside of the building 12 including the production line 10. The map of the inside of the building 12 may be stored in advance in the transport robot 6. Before the transport robot 6 transports the body 11, the transport robot 6 may autonomously travel inside the building 12 and create the map 661 during travel using the scanners 65.

The transport robot 6 includes a communication circuit 67. The communication circuit 67 performs wireless communication with the control panel 19. The communication circuit 67 can receive control signals from the control panel 19. The communication circuit 67 can transmit, for example, position information of the transport robot 6 to the control panel 19.

The transport robot 6 includes a rotary table 68. The rotary table 68 is located on the upper surface of the transport robot 6. The rotary table 68 engages with the body 11 via the transport platform 14. The rotary table 68 rotates about a vertical axis in both clockwise and counterclockwise directions. The rotary table 68 rotates relative to the body of the transport robot 6. The rotary table 68 includes a drive source. The drive source is, for example, an electric motor. The electric motor includes a servomotor or a stepping motor. More specifically, the rotary table 68 includes a rotary motor that rotates the rotary table 68 about the vertical axis, and a lift motor that raises and lowers the rotary table 68. When the rotary table 68 rotates while the transport robot 6 is stationary, the body 11 rotates about the vertical axis via the transport platform 14. The body 11 can rotate in place without moving in the longitudinal direction or the lateral direction. By the transport robot 6 rotating in place through the driving of the drive wheels 611, 612 and the rotary table 68 rotating, the orientation of the transport robot 6 can be changed without changing the orientation of the body 11.

The transport robot 6 includes the controller 69. The controller 69 controls the transport robot 6. The controller 69 is electrically connected to the motors 631, 632, the scanners 65, the storage 66, the communication circuit 67, and the rotary table 68. The controller 69 receives control signals from the system controller 16 through the control panel 19 and the communication circuit 67, and causes the transport robot 6 to perform operations corresponding to the received control signals. The transport robot 6 autonomously travels along the predetermined route 15 to a position designated by the system controller 16, namely the work area 13 for the industrial robots 2. More specifically, the controller 69 outputs travel control signals to the motors 631, 632 to control the rotational speeds of the drive wheels 61 so that the transport robot 6 travels straight, changes its direction of travel, or pivots in place (turns in place). The controller 69 thus controls the transport robot 6 to travel autonomously to the work area 13. Upon receiving the travel control signals, the motors 631, 632 rotate at speeds corresponding to the received travel control signals to drive the drive wheels 61.

During travel of the transport robot 6, the controller 69 causes the transport robot 6 to travel along the predetermined route 15. While the transport robot 6 is traveling, the controller 69 estimates the position of the transport robot 6 based on signals from the scanners 65 and the map 661. The transport robot 6 determines, based on its estimated position, whether it has reached the work area 13. By autonomously traveling along the route 15 to the work area 13, the transport robot 6 transports the body 11 to the work area 13.

### Monitoring of Transport Robot

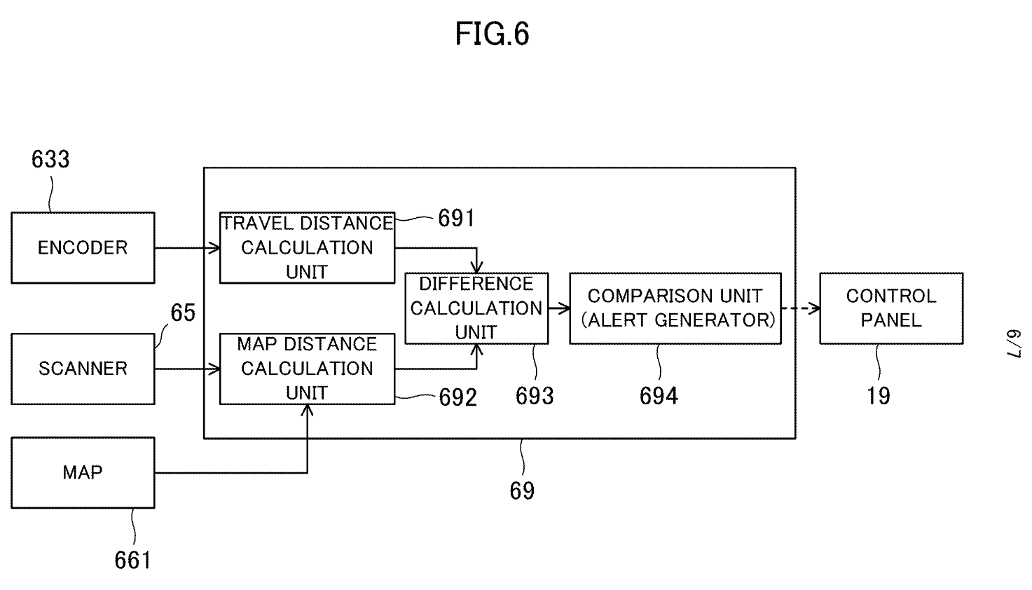

The robot system 1 generates an alert related to the environment of the transport robot 6 or an alert related to the drive wheels 61 of the transport robot 6 by monitoring the traveling state of the transport robot 6. FIG. 6 illustrates functional blocks of the controller 69 of the transport robot 6. The controller 69 includes, as functional blocks, a travel distance calculation unit 691 and a map distance calculation unit 692.

The travel distance calculation unit 691 calculates the travel distance of the transport robot 6 along the route 15 based on information related to the rotation of the drive wheels 61 of the transport robot 6. Specifically, the travel distance is calculated based on the travel distance per unit time πD0 × n. The travel distance per unit time πD0 × n is calculated from the initial diameter D0 of the drive wheel 61 shown in FIG. 5 and information on the rotational speed n that is based on signals from the encoders 633. The travel distance calculated by the travel distance calculation unit 691 is based on odometry.

The travel distance calculation unit 691 calculates the travel distance based on the initial diameter D0 stored in advance. In a case where the diameter of the drive wheel 61 decreases to D1 due to wear of the tire 60, the distance traveled by the transport robot 6 per one rotation of the drive wheel 61 becomes shorter. That is, the number of rotations of the drive wheels 61 until the transport robot 6 reaches the target position based on its estimated position increases. In a case where the diameter of the drive wheel 61 decreases to D1, the travel distance calculated by the travel distance calculation unit 691 becomes longer than the actual distance traveled by the transport robot 6. If the drive wheels 61 slip on the floor surface 120, the transport robot 6 does not advance even through the drive wheels 61 rotate. Therefore, the travel distance calculated by the travel distance calculation unit 691 based on the rotational speed of the drive wheel 61 becomes longer than the actual distance traveled by the transport robot 6.

The route 15 of the transport robot 6 is divided into sections. FIG. 1 includes a first section 91, a second section 92, a third section 93, a fourth section 94, a fifth section 95, and a sixth section 96. However, the number of sections is not limited to six. The travel distance calculation unit 691 calculates, for each section 91, 92, 93, 94, 95, 96, the travel distance DT91, DT92, DT93, DT94, DT95, DT96 each time the transport robot 6 passes through the respective section.

The map distance calculation unit 692 calculates the distance on a map (hereinafter referred to as “map distance”) corresponding to the route 15 traveled by the transport robot 6, based on the position of the transport robot 6 estimated using the map 661 and the scanners 65. The map distance calculation unit 692 calculates, for each section 91, 92, 93, 94, 95, 96, the map distance DM91, DM92, DM93, DM94, DM95, DM96 each time the transport robot 6 passes through the respective section. The map distance calculated by the map distance calculation unit 692 is an example of an actual distance corresponding to the route 15 traveled by the transport robot 6. Instead of the map distance calculation unit 692 calculating the map distance based on the map 661, the controller 69 may calculate the actual distance traveled by the transport robot 6 based on actual measurement.

The controller 69 includes, as a functional block, a difference calculation unit 693. The difference calculation unit 693 calculates differences between the travel distances DT91, DT92, DT93, DT94, DT95, and DT96 calculated by the travel distance calculation unit 691 and the map distances DM91, DM92, DM93, DM94, DM95, and DM96 calculated by the map distance calculation unit 692. That is, the difference calculation unit 693 calculates the difference between the travel distance and the map distance for each section.

The controller 69 includes, as a functional block, a comparison unit 694. The comparison unit 694 compares, for each section, the difference calculated for that section with a predetermined threshold. In a case where the difference exceeds the threshold, the comparison unit 694 generates an alert to the control panel 19. The comparison unit 694 is an example of an alert generator.

More specifically, in a case where the difference exceeds the threshold in two or more sections, the comparison unit 694 determines that at least one of the tires 60 of the drive wheels 61 is worn. That is, in a case where the diameter of the drive wheel 61 is smaller than the initial diameter, the travel distance calculated by the travel distance calculation unit 691 becomes longer than the map distance regardless of which section the transport robot 6 travels. The comparison unit 694 may alternatively determine that at least one of the tires 60 of the drive wheels 61 is worn, in a case where the difference exceeds the threshold in all of the sections.

In contrast, in a case where the difference exceeds the threshold in a specific section, the comparison unit 694 determines that at least one of the drive wheels 61 is slipping in that section. The specific section may be one section or two or more non-contiguous sections. In a case where the difference exceeds the threshold in one or more sections and does not exceed the threshold one or more sections, the comparison unit 694 may determine that at least one of the drive wheels 61 is slipping in the one or more sections where the difference exceeds the threshold.

As shown in FIG. 3, the control panel 19 includes a display 191. In response to an alert generated by the transport robot 6, the control panel 19 displays the alert on the display 191. In accordance with the alert from the transport robot 6, the display 191 displays an alert related to wear of the tires 60 of the drive wheels 61, or an alert related to slipping that has occurred in a specific section of the route 15. An operator managing the robot system 1 replaces the tires 60 of the drive wheels 61 or checks the specific section where slipping has occurred, in accordance with the alert displayed on the display 191.

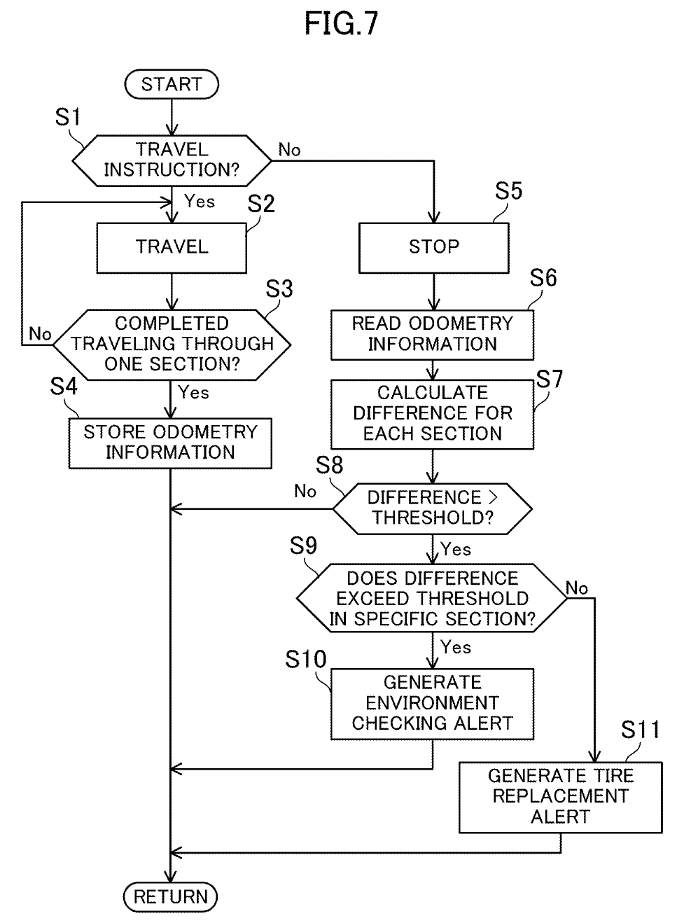

FIG. 7 is a flowchart of control of the transport robot 6. After the control is started, the transport robot 6 determines in step S1 whether a travel instruction has been received from the system controller 16. In a case where a travel instruction is received, the transport robot 6 travels in step S2.

In step S3, the transport robot 6 determines whether it has completed traveling through one section, and continues traveling in step S2 until it has completed traveling through one section.

In a case where the transport robot 6 has completed traveling through one section in step S3, it stores odometry information of the section in the storage 66 in step S4. The odometry information is the travel distance in the section calculated by the travel distance calculation unit 691 based on information related to the rotation of the drive wheels 61. After step S4, when the transport robot 6 continues traveling, the process of FIG. 7 repeats steps S1, S2, S3, and S4. In a case where the transport robot 6 travels through two or more sections, the transport robot 6 individually stores odometry information for each of the sections. Instead of the storage 66 storing the odometry information, or in addition to the storage 66 storing the odometry information, the control panel 19 may receive the odometry information from the transport robot 6 and store the odometry information.

In a case where a travel instruction is not received in step S1, for example, in a case where the transport robot 6 has completed traveling to the position designated by the system controller 16, the transport robot 6 stops in step S5. Thereafter, in step S6, the transport robot 6 reads the odometry information from the storage 66, and in step S7, calculates, for each section, the difference between the travel distance DT91, DT92, … and the map distance DM91, DM92, …. In step S8, the transport robot 6 determines, for each section, whether the difference exceeds the threshold.

In a case where the difference does not exceed the threshold in any of the sections, the transport robot 6 determines that neither wear of the tires 60 nor slipping of the drive wheels 61 has occurred. The process of FIG. 7 then returns to the start.

In a case where the difference exceeds the threshold in any of the sections, the transport robot 6 determines in step S9 whether the difference exceeds the threshold in a specific section alone. In a case where Yes in step S9, the transport robot 6 determines that slipping of at least one of the drive wheels 61 has occurred in the specific section, and generates in step S10 an alert regarding checking the environment of the specific section in the route 15. In a case where No in step S9, the transport robot 6 determines that at least one of the tires 60 of the drive wheels 61 is worn, and generates in step S11 an alert regarding replacement of the tires 60.

### Functions and Effects

For example, when the tires 60 of the drive wheels 61 are replaced based on the number of days of use of the transport robot 6, the tires 60 may be replaced even if they are not worn. Similarly, when the tires 60 of the drive wheels 61 are replaced based on the travel distance of the transport robot 6, the tires 60 may be replaced even if they are not worn.

Since the transport robot 6 transports workpieces, the degree of progress of wear of the tires 60 varies depending on the weight of the workpieces transported by the transport robot 6. When replacement of the tires 60 is attempted based on the number of days of use or the travel distance, the timing of replacement of the tires 60 may be delayed.

In a case where the robot system 1 includes two or more transport robots 6, the degree of wear of the tires 60 may vary among the transport robots 6.

The robot system 1 can accurately estimate the wear of the tires 60 of the individual transport robots 6 by comparing the travel distances DT91, DT92, … calculated based on odometry information with the map distances DM91, DM92, … calculated based on the map 661. This makes it possible to replace the tires 60 at an appropriate timing.

The robot system 1 calculates, for each section, the travel distance based on odometry information, and compares the travel distance and the map distance for each section. Based on this comparison information, the robot system 1 can distinguish between wear of the tires 60 and slipping of the drive wheels 61 in a specific section. This also makes it possible to replace the tires 60 at an appropriate timing. Since slipping of the drive wheels 61 in a specific section can be detected, the cause of the slip can be eliminated.

The AGV as the transport robot 6 travels along the predetermined route 15. The robot system 1 can accurately perform comparison between the travel distance along the route 15 and the map distance corresponding to the route 15 traveled by the transport robot 6.

### Modifications

In the flow of FIG. 7, after the transport robot 6 stops traveling, the transport robot 6 performs comparison between the travel distance along the route 15 and the map distance corresponding to the route 15 traveled by the transport robot 6 and determines whether to generate an alert in steps S6 to S11. Alternatively, the transport robot 6 may perform steps S6 to S11 each time it passes through a section while traveling.

In the flow of FIG. 7, the slip of the drive wheels 61 in a specific section is determined based on the traveling state of one transport robot 6. Alternatively, the slip of the drive wheels 61 in a specific section may be determined based on the traveling states of two or more transport robots 6. For example, in a case where the difference between the travel distance DT91, DT92, … and the map distance DM91, DM92, … of a first transport robot 6 exceeds the threshold in a certain section, and the difference between the travel distance DT91, DT92, … and the map distance DM91, DM92, … of a second transport robot 6 also exceeds the threshold in the same section, it is highly probable that the environment of that section has deteriorated, that is, that a cause of the slip exists in that section. The robot system 1 may determine whether to generate an alert based on the traveling states of two or more transport robots 6. As the number of transport robots 6 increases, the reliability of determining environmental factors increases. For example, in a case where the difference between the travel distance DT91, DT92, … and the map distance DM91, DM92, … of a first transport robot 6 exceeds the threshold in a certain section, but the differences between the travel distance DT91, DT92, … and the map distance DM91, DM92, … of second and third transport robots 6 do not exceed the threshold in the same section, it is possible that a malfunction occurred in the first transport robot 6, or that a temporary environmental factor occurred (for example, the scanner 65 made an erroneous detection due to sunlight, a water droplet on the floor dried immediately, or the first transport robot 6 ran over a small stone).

In the robot system 1 described above, the transport robot 6 determines whether to generate an alert in steps S6 to S11. Alternatively, the control panel 19 may receive odometry information from the transport robot 6 and determine whether to generate an alert in accordance with steps S6 to S11, or the system controller 16 may determine whether to generate an alert in accordance with steps S6 to S11.

In the robot system 1 described above, the display 191 of the control panel 19 displays alerts. However, alerts may not be displayed on the control panel 19. For example, an information terminal (e.g., a tablet) that can communicate with the control panel 19 may display alerts based on information received from the control panel 19. Alternatively, an information terminal that can communicate with the transport robot 6 may display alerts based on information received from the transport robot 6. The transport robot 6 may include a display and may display alerts on the display. Alerts may not be provided by display. For example, the transport robot 6 may provide alerts by voice.

The transport robot 6 is not limited to an AGV. For example, the transport robot 6 may be an autonomous mobile robot (AMR). An AMR has a SLAM function. Therefore, the use of an AMR eliminates the need for magnetic tape on the floor surface 120.

The functionality of the elements disclosed herein may be implemented using one or more circuitry or processing circuitry which includes general purpose processors, special purpose processors, integrated circuits, application-specific integrated circuits (ASICs), field programmable gate arrays (FPGAs) and/or conventional circuitry. The functionality of the elements disclosed herein may be implemented using one or more circuitry or processing circuitry which includes combinations of general purpose processors, special purpose processors, integrated circuits, ASICs, FPGAs, or conventional circuitry. The one or more circuitry or processing circuitry is programmed, using one or more programs stored together or individually in one or more memories, or otherwise configured to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality, alone or in combination with one another. The hardware may be any hardware disclosed herein which is programmed or configured to carry out the recited functionality.

There is a memory that stores a computer program which includes computer instructions. The computer instructions provide the logic and routines that enable the hardware to perform the method disclosed herein. The hardware includes, e.g., processing circuitry or circuitry. The computer program can be implemented in known formats as a computer-readable storage medium, a computer program product, a memory device, a record medium such as CD-ROM or DVD, and/or the memory of FPGAs or ASICs.

### Aspects

The embodiment described above is a specific example of the following aspects.

### First Aspect

A robot monitoring method includes: acquiring information related to rotation of a wheel (61) of a robot (6) while the robot (6) is traveling along a route (15) in a specific area (12); calculating, by a calculation circuit (69), a travel distance (DT91, DT92, …) of the robot (6) along the route (15) based on the acquired information; calculating, by the calculation circuit (69), an actual distance (DM91, DM92, …) corresponding to the route (15) traveled by the robot (6); and in a case where the difference between the calculated travel distance (DT91, DT92, …) and the actual distance (DM91, DM92, …) is greater than a predetermined threshold, generating, by an alert generator (69), an alert regarding wear of the wheel (61) of the robot (6).

The calculation circuit (69) calculates the travel distance (DT91, DT92, …) of the robot (6) along the route (15) based on odometry information. The calculation circuit (69) also calculates the actual distance (DM91, DM92, …) corresponding to the route (15) traveled by the robot (6).

In a case where the wheel (61) of the robot (6) wears over time and the diameter of the wheel (61) becomes smaller than its initial diameter, the travel distance of the robot (6) per one rotation of the wheel (61) becomes shorter than at the initial stage. As a result, the travel distance (DT91, DT92, …) becomes longer than the actual distance (DM91, DM92, …).

In a case where the difference between the calculated travel distance (DT91, DT92, …) and the actual distance (DM91, DM92, …) is greater than the predetermined threshold, the alert generator (69) generates an alert regarding wear of the wheel (61). Wear of the wheel (61) can thus be detected promptly.

### Second Aspect

In the robot monitoring method of the first aspect, the calculation circuit (69) calculates, as the actual distance, a map distance (DM91, DM92, …) corresponding to the route (15) traveled by the robot (6), based on a map (661) of the specific area.

By using the map (661) of the specific area, the calculation circuit (69) can accurately calculate the actual distance traveled by the robot (6).

### Third Aspect

In the robot monitoring method of the first or second aspect, the robot (6) travels through a first section (91, 92, 93, 94, 95, 96) and a second section (91, 92, 93, 94, 95, 96) of the route (15), and the calculation circuit (69) calculates a first travel distance (DT91, DT92, DT93, DT94, DT95, DT96) in the first section (91, 92, 93, 94, 95, 96) and a second travel distance (DT91, DT92, DT93, DT94, DT95, DT96) in the second section (91, 92, 93, 94, 95, 96).

Calculating the travel distance (DT91, DT92, DT93, DT94, DT95, DT96) for each section (91, 92, 93, 94, 95, 96) makes it possible to detect the wear of the wheel (61).

### Fourth Aspect

In the robot monitoring method of the third aspect, in a case where the difference between the first travel distance (DT91, DT92, DT93, DT94, DT95, DT96) and a first actual distance (DM91, DM92, DM93, DM94, DM95, DM96) corresponding to the first section is greater than the predetermined threshold, and the difference between the second travel distance (DT91, DT92, DT93, DT94, DT95, DT96) and a second actual distance (DM91, DM92, DM93, DM94, DM95, DM96) corresponding to the second section is greater than the predetermined threshold, the alert generator (69) generates the alert regarding wear of the wheel (61).

In a case where, regardless of the sections traveled by the robot (6), the difference between the travel distance (DT91, DT92, DT93, DT94, DT95, DT96) and the actual distance (DM91, DM92, DM93, DM94, DM95, DM96) is large in two or more sections, it can be determined that the wheel (61) is worn.

### Fifth Aspect

In the robot monitoring method of the third or fourth aspect, in a case where the difference between the first travel distance (DT91, DT92, DT93, DT94, DT95, DT96) and the first actual distance (DM91, DM92, DM93, DM94, DM95, DM96) is greater than the predetermined threshold and the difference between the second travel distance (DT91, DT92, DT93, DT94, DT95, DT96) and the second actual distance (DM91, DM92, DM93, DM94, DM95, DM96) is less than or equal to the predetermined threshold, or in a case where the difference between the first travel distance (DT91, DT92, DT93, DT94, DT95, DT96) and the first actual distance (DM91, DM92, DM93, DM94, DM95, DM96) is less than or equal to the predetermined threshold and the difference between the second travel distance (DT91, DT92, DT93, DT94, DT95, DT96) and the second actual distance (DM91, DM92, DM93, DM94, DM95, DM96) is greater than the predetermined threshold, the alert generator (69) generates an alert regarding an environment of the specific area (12).

In a case where the difference between the travel distance (DT91, DT92, DT93, DT94, DT95, DT96) and the actual distance (DM91, DM92, DM93, DM94, DM95, DM96) is large in a specific section, it can be estimated that a cause exists in the specific section (91, 92, 93, 94, 95, 96).

### Sixth Aspect

In the robot monitoring method of the fifth aspect, the alert generated in a case where the difference between the first travel distance (DT91, DT92, DT93, DT94, DT95, DT96) and the first actual distance (DM91, DM92, DM93, DM94, DM95, DM96) is greater than the predetermined threshold and the difference between the second travel distance (DT91, DT92, DT93, DT94, DT95, DT96) and the second actual distance (DM91, DM92, DM93, DM94, DM95, DM96) is less than or equal to the predetermined threshold is an alert indicating slipping of the wheel in the first section (91, 92, 93, 94, 95, 96). The alert generated in a case where the difference between the first travel distance (DT91, DT92, DT93, DT94, DT95, DT96) and the first actual distance (DM91, DM92, DM93, DM94, DM95, DM96) is less than or equal to the predetermined threshold and the difference between the second travel distance (DT91, DT92, DT93, DT94, DT95, DT96) and the second actual distance (DM91, DM92, DM93, DM94, DM95, DM96) is greater than the predetermined threshold is an alert indicating slipping of the wheel in the second section (91, 92, 93, 94, 95, 96).

### Seventh Aspect

In the robot monitoring method of the fifth or sixth aspect, in a case where the difference between the first travel distance (DT91, DT92, …) of the robot (6) and the first actual distance (DM91, DM92, …) is greater than the predetermined threshold and the difference between the second travel distance (DT91, DT92, …) of the robot (6) and the second actual distance (DM91, DM92, …) is less than or equal to the predetermined threshold, and the difference between the first travel distance (DT91, DT92, …) of a second robot (6) and the first actual distance (DM91, DM92, …) is greater than the predetermined threshold and the difference between the second travel distance (DT91, DT92, …) of the second robot (6) and the second actual distance (DM91, DM92, …) is less than or equal to the predetermined threshold, the alert generator generates an alert regarding an environment of the first section. In a case where the difference between the first travel distance (DT91, DT92, …) of the robot (6) and the first actual distance (DM91, DM92, …) is less than or equal to the predetermined threshold and the difference between the second travel distance (DT91, DT92, …) of the robot (6) and the second actual distance (DM91, DM92, …) is greater than the predetermined threshold, and the difference between the first travel distance (DT91, DT92, …) of the second robot (6) and the first actual distance (DM91, DM92, …) is greater than the predetermined threshold and the difference between the second travel distance (DT91, DT92, …) of the second robot (6) and the second actual distance (DM91, DM92, …) is less than or equal to the predetermined threshold, the alert generator generates an alert regarding an environment of the second section.

In a case where, for each of robots (6) including the robot (6) and the second robot (6), the difference between the first travel distance (DT91, DT92, …) and the first actual distance (DM91, DM92, …) is large, it is highly probable that some cause exists in the environment of the first section. The alert generator therefore generates an alert regarding the environment of the first section.

Similarly, in a case where, for each of the robots (6) including the robot (6) and the second robot (6), the difference between the second travel distance (DT91, DT92, …) and the second actual distance (DM91, DM92, …) is large, it is highly probable that some cause exists in the environment of the second section. The alert generator therefore generates an alert regarding the environment of the second section.

### Eighth Aspect

In the robot monitoring method of any one of the first to seventh aspects, the robot (6) autonomously travels in the specific area (12) while estimating the position of the robot (6) using a map (661) and a scanner (65) that detects a surrounding environment.

The robot (6) can calculate the actual distance (DM91, DM92, …) by estimating its own position.

### Ninth Aspect

In the robot monitoring method of the eighth aspect, the robot (6) is an AGV that travels along the route (15) determined in advance.

Since the AGV travels along the route (15) determined in advance, the travel distance (DT91, DT92, …) along the route (15) based on odometry information can be compared with the actual distance (DM91, DM92, …) based on the map (661).

### Tenth Aspect

In the robot monitoring method of the eighth or ninth aspect, the robot (6) is a transport robot that transports a workpiece (11) in the specific area (12).

The degree of progress of wear of the wheel (61) varies depending on the weight of workpieces transported by the robot (6). A comparison between the travel distance (DT91, DT92, …) and the actual distance (DM91, DM92, …) enables highly accurate estimation of the wear of the wheel (61).

### Eleventh Aspect

A robot system (1) includes: a robot (6) that travels along a route (15) in a specific area (12) and including a wheel (61) that rolls on a floor surface (120) of the specific area (12); a sensor (633) that outputs a signal related to rotation of the wheel (61) while the robot (6) is traveling along the route (15); a calculation circuit (69) that calculates a travel distance (DT91, DT92, …) of the robot (6) along the route (15) based on the signal from the sensor (633), and that calculates an actual distance (DM91, DM92, …) corresponding to the route (15) traveled by the robot (6); and an alert generator (69) that generates an alert regarding wear of the wheel (61) of the robot (6) in a case where the difference between the calculated travel distance (DT91, DT92, …) and the actual distance (DM91, DM92, …) is greater than a predetermined threshold.

1. A robot monitoring method comprising:
acquiring information related to rotation of a wheel of a robot while the robot is traveling along a route in a specific area;
calculating, by a calculation circuit, a travel distance of the robot along the route based on the acquired information;
calculating, by the calculation circuit, an actual distance corresponding to the route traveled by the robot; and
in a case where a difference between the calculated travel distance and the actual distance is greater than a predetermined threshold, generating, by an alert generator, an alert regarding wear of the wheel of the robot.

2. The robot monitoring method of claim 1, wherein
the calculation circuit calculates, as the actual distance, a map distance corresponding to the route traveled by the robot, based on a map of the specific area.

3. The robot monitoring method of claim 1, wherein
the robot travels through a first section and a second section of the route, and
the calculation circuit calculates a first travel distance in the first section and a second travel distance in the second section.

4. The robot monitoring method of claim 3, wherein
in a case where a difference between the first travel distance and a first actual distance corresponding to the first section is greater than the predetermined threshold, and a difference between the second travel distance and a second actual distance corresponding to the second section is greater than the predetermined threshold, the alert generator generates the alert regarding wear of the wheel.

5. The robot monitoring method of claim 4, wherein
in a case where the difference between the first travel distance and the first actual distance is greater than the predetermined threshold and the difference between the second travel distance and the second actual distance is less than or equal to the predetermined threshold, or in a case where the difference between the first travel distance and the first actual distance is less than or equal to the predetermined threshold and the difference between the second travel distance and the second actual distance is greater than the predetermined threshold, the alert generator generates an alert regarding an environment of the specific area.

6. The robot monitoring method of claim 5, wherein
the alert generated in a case where the difference between the first travel distance and the first actual distance is greater than the predetermined threshold and the difference between the second travel distance and the second actual distance is less than or equal to the predetermined threshold is an alert indicating slipping of the wheel in the first section, and
the alert generated in a case where the difference between the first travel distance and the first actual distance is less than or equal to the predetermined threshold and the difference between the second travel distance and the second actual distance is greater than the predetermined threshold is an alert indicating slipping of the wheel in the second section.

7. The robot monitoring method of claim 5, wherein
in a case where the difference between the first travel distance of the robot and the first actual distance is greater than the predetermined threshold and the difference between the second travel distance of the robot and the second actual distance is less than or equal to the predetermined threshold, and the difference between the first travel distance of a second robot and the first actual distance is greater than the predetermined threshold and the difference between the second travel distance of the second robot and the second actual distance is less than or equal to the predetermined threshold, the alert generator generates an alert regarding an environment of the first section, and
in a case where the difference between the first travel distance of the robot and the first actual distance is less than or equal to the predetermined threshold and the difference between the second travel distance of the robot and the second actual distance is greater than the predetermined threshold, and the difference between the first travel distance of the second robot and the first actual distance is greater than the predetermined threshold and the difference between the second travel distance of the second robot and the second actual distance is less than or equal to the predetermined threshold, the alert generator generates an alert regarding an environment of the second section.

8. The robot monitoring method of claim 1, wherein
the robot autonomously travels in the specific area while estimating a position of the robot using a map and a scanner that detects a surrounding environment.

9. The robot monitoring method of claim 8, wherein
the robot is an automatic guided vehicle that travels along the route determined in advance.

10. The robot monitoring method of claim 8, wherein
the robot is a transport robot that transports a workpiece in the specific area.

11. A robot system comprising:
a robot that travels along a route in a specific area, the robot including a wheel that rolls on a floor surface of the specific area;
a sensor that outputs a signal related to rotation of the wheel while the robot is traveling along the route;
a calculation circuit that calculates a travel distance of the robot along the route based on the signal from the sensor, and that calculates an actual distance corresponding to the route traveled by the robot; and
an alert generator that generates an alert regarding wear of the wheel of the robot in a case where a difference between the calculated travel distance and the actual distance is greater than a predetermined threshold.
